(19) United States
(12) Patent Application Publication
(10) Pub. No.: US 2026/0311174 A1
(43) Pub. Date: Oct. 8, 2026

(54) METHOD FOR PROVIDING INTEROPERABILITY BETWEEN HETEROGENEOUS BLOCKCHAINS AND APPARATUS FOR THE SAME

(71) Applicant: DREAMSECURITY CO., LTD., Seongdong-gu, Seoul (KR)

(72) Inventors: Mi-Kyeong Kim, Sosa-gu, Bucheon-si, Gyeonggi-do (KR); Young-Jin Kim, Seo-gu, Daejeon (KR); Won-Chan Kim, Songpa-gu, Seoul (KR); Eun-Yeong Song, Icheon-si, Gyeonggi-do (KR)

(21) Appl. No.: 18/996,750

(22) PCT Filed: Jul. 12, 2024
(86) PCT No.: PCT/KR2024/010011

§ 371 Date: Jan. 17, 2025

(30) Foreign Application Priority Data
Nov. 20, 2023 (KR) 10-2023-0160376
Jul. 8, 2024 (KR) 10-2024-0089357

(51) Int. Cl. G06Q 20/38

(52) U.S. Cl. CPC G06Q 20/389

(57) ABSTRACT

A method for providing interoperability between blockchains by a blockchain connection relay server according to an embodiment of the present disclosure includes determining an asset type corresponding to interoperation between the blockchains and processing one or more transactions corresponding to the interoperation depending on the asset type.

### CROSS-REFERENCE TO RELATED APPLICATIONS

This application is a national phase entry under 35 U.S.C. § 371 of International Patent Application PCT/KR 2024/010011, filed Jul. 12, 2024, designating the United States of America, which claims the benefit under Article 8 of the Patent Cooperation Treaty of Korean Patent Application Serial No. 10-2023-0160376, filed Nov. 20, 2023, and Korean Patent Application Serial No. 10-2024-0089357, filed Jul. 8, 2024, the entire disclosures of which are hereby incorporated herein in their entireties by this reference.

### TECHNICAL FIELD

The present disclosure relates generally to blockchain technology, and more particularly, to technology for providing interoperability between heterogeneous blockchains.

### BACKGROUND

Blockchain is a mechanism that allows all nodes to share the same transaction ledger even in a distributed system environment in which they cannot trust each other. As a representative application example, there is Bitcoin.

Also, a smart contract is a programmable contract and enables all nodes to perform transactions in the same order in a distributed system environment, in addition to simply trading assets such as coins. As a representative open project related to this, there is Ethereum.

Blockchains may be broadly divided into public blockchains, private blockchains, and consortium blockchains, and there are several types of blockchains that use different consensus algorithms.

As services related to blockchain become more complex and diverse, interoperability between heterogeneous blockchains may be required.

Korean Patent No. 10-2221328 discloses technology for providing a low-complexity and high-scalability cross-chain network between different blockchains that are mutually isolated.

However, the technology disclosed in Korean Patent No. 10-2221328 focuses on providing a cross-chain network between two different blockchains, and it is difficult to apply the technology to an environment in which it is required to provide interoperability for more diverse heterogeneous blockchains.

Therefore, there is an urgent need for new technology that can provide interoperability for various heterogeneous blockchains.

### BRIEF SUMMARY

An object of the present disclosure is to provide interoperability between heterogeneous blockchains with different characteristics.

Another object of the present disclosure is to efficiently provide interoperability between public/private/consortium blockchains or between blockchains using different consensus algorithms.

A further object of the present disclosure is to efficiently provide interoperability between blockchains based on an operation type, such as exchange, transfer, or the like, and/or on a transaction type, such as Write/Write (WW), Read/Write (RW), or the like.

In order to accomplish the above objects, a method for providing interoperability between blockchains, in which a blockchain connection relay server provides interoperability between the blockchains, includes determining an asset type corresponding to interoperation between the blockchains and processing one or more transactions corresponding to the interoperation depending on the asset type.

Here, the asset type may be determined based on whether an asset corresponding to the interoperation includes a coin/token.

Here, the asset type may be determined based on whether the asset corresponding to the interoperation includes a message.

Here, the asset type may be selected from a group including a first type in which an asset corresponding to the interoperation includes a message and does not include a coin/token, a second type in which the asset corresponding to the interoperation includes a coin/token and does not include a message, and a third type in which the asset corresponding to the interoperation includes both a message and a coin/token.

Here, the blockchains may include offchain.

Here, transaction processing corresponding to the first type may be performed based on a blockchain bridging direction check process, which is based on a blockchain bridging direction, and a bridging consensus algorithm direction check process, which is based on a bridging consensus algorithm direction.

Here, the blockchain bridging direction may be determined based on whether a source corresponding to the interoperation is a private blockchain (and/or a consortium blockchain). That is, the private blockchain may include a consortium blockchain or a public blockchain if the operator thereof is clear.

Here, the bridging consensus algorithm direction may be determined to be a forward direction when the number of consensus nodes of a blockchain consensus committee corresponding to the source is greater than the number of consensus nodes of a blockchain consensus committee corresponding to the destination of the interoperation, and may be determined to a reverse direction when the number of consensus nodes of the blockchain consensus committee corresponding to the source is less than the number of consensus nodes of the blockchain consensus committee corresponding to the destination of the interoperation.

Here, transaction processing corresponding to the first type may comprise generating a message indicating that processing is not possible if the bridging consensus algorithm direction is a reverse direction when the source corresponding to the interoperation is a private blockchain.

Here, processing the one or more transactions may be performed based on an operation type check process, which is based on an operation type corresponding to the interoperation, and a transaction type check process, which is based on a transaction type corresponding to the interoperation and is performed when the operation type is ‘transfer.’ Here, the operation type check process may be performed depending on whether the operation type is ‘transfer’ or ‘exchange.’

Here, the transaction type check process may be performed depending on whether the transaction type is Write/Write (WW) or Read/Write (RW).

Also, an apparatus for providing interoperability between blockchains according to an embodiment of the present disclosure includes one or more processors and executable memory for storing at least one program executed by the one or more processors.

Here, the at least one program determines an asset type corresponding to interoperation between the blockchains and processes one or more transactions corresponding to the interoperation depending on the asset type.

Here, the asset type may be selected from a group including a first type in which an asset corresponding to the interoperation includes a message and does not include a coin/token, a second type in which the asset corresponding to the interoperation includes a coin/token and does not include a message, and a third type in which the asset corresponding to the interoperation includes both a message and a coin/token.

Here, transaction processing corresponding to the first type may be performed based on a blockchain bridging direction check process, which is based on a blockchain bridging direction, and a bridging consensus algorithm direction check process, which is based on a bridging consensus algorithm direction.

According to the present disclosure, it is possible to provide interoperability between heterogeneous blockchains with different characteristics.

Also, the present disclosure may efficiently provide interoperability between public/private blockchains or between blockchains using different consensus algorithms.

Also, the present disclosure may efficiently provide interoperability between blockchains based on an operation type, such as exchange, transfer, or the like, and/or on a transaction type, such as WW, RW, or the like.

### BRIEF DESCRIPTION OF THE DRAWINGS

FIG. 1 is a block diagram illustrating a blockchain interoperation system according to an embodiment of the present disclosure.

FIG. 2 is a view illustrating the software hierarchy of the blockchain interoperation system illustrated in FIG. 1.

FIG. 3 is a view illustrating the software processing flow of the blockchain interoperation system illustrated in FIG. 1.

FIG. 4 is a view illustrating an online blockchain data source authentication process according to an embodiment of the present disclosure.

FIG. 5 is a block diagram illustrating an example of an apparatus for providing interoperability between heterogeneous blockchains according to an embodiment of the present disclosure.

FIG. 6 is a flowchart illustrating a method for providing interoperability between heterogeneous blockchains according to an embodiment of the present disclosure.

FIG. 7 is a flowchart illustrating an example of the step of transaction processing for each asset type illustrated in FIG. 6.

FIG. 8 is a flowchart illustrating an example of the first-type transaction processing step illustrated in FIG. 7.

FIG. 9 is a flowchart illustrating an example of the second-type transaction processing step illustrated in FIG. 7.

FIG. 10 is a flowchart illustrating an example of the third-type transaction processing step illustrated in FIG. 7.

FIG. 11 is a view illustrating a message structure according to an embodiment of the present disclosure.

FIG. 12 is a block diagram illustrating a computer system configuration according to an embodiment of the present disclosure.

### DETAILED DESCRIPTION

The advantages and features of the present disclosure and methods of achieving them will be apparent from the following embodiments to be described in more detail with reference to the accompanying drawings. However, the present disclosure is implemented in various forms, rather than being limited to the following embodiments. These embodiments are provided only to disclose the present disclosure and to let those skilled in the art to which the present disclosure pertains know the category of the present disclosure, and the present disclosure is to be defined based only on the claims. The same reference numerals denote the same elements throughout the present disclosure.

Although the terms “first,” “second,” etc., are used to describe various elements, these elements are not intended to be limited by these terms. These terms may be only used to distinguish one element from another element. Accordingly, a first element discussed below could be referred to as a second element without departing from the technical spirit of the present disclosure.

The terms used herein are for the purpose of describing embodiments only and are not intended to limit the present disclosure. As used herein, the singular forms are intended to include the plural forms as well, unless the context clearly indicates otherwise. The terms “comprises,” or “comprising,” when used herein, specify the presence of stated elements or steps, but do not preclude the presence or addition of one or more other elements or steps.

Unless differently defined, all terms used herein may be interpreted as having meanings generally understood by those skilled in the art to which the present disclosure pertains. Terms defined in generally used dictionaries are not to be interpreted as having ideal or excessively formal meanings unless they are definitively defined.

Hereinafter, embodiments of the present disclosure will be described in detail with reference to the accompanying drawings. In the following description, the same reference numerals are used to designate the same or similar elements throughout the drawings, and repeated descriptions of the same elements will be omitted.

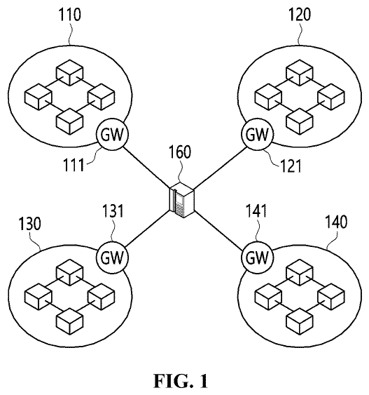

FIG. 1 is a block diagram illustrating a blockchain interoperation system according to an embodiment of the present disclosure.

Referring to FIG. 1, the blockchain interoperation system according to an embodiment of the present disclosure includes different blockchain systems 110, 120, 130, and 140 and a blockchain connection relay server 160. Here, the blockchain system 110 may include a blockchain connection server 111, the blockchain system 120 may include a blockchain connection server 121, the blockchain system 130 may include a blockchain connection server 131, and the blockchain system 140 may include a blockchain connection server 141.

Although not explicitly illustrated in FIG. 1, the blockchain systems 110, 120, 130, and 140 may include offchain systems.

Here, each of the blockchain connection servers 111, 121, 131, and 141 may serve as a gateway (GW) and may only provide connection with the blockchain connection relay server 160 without the need to provide the interconnection between the blockchain systems 110, 120, 130 and 140. Because the connection for interoperation between blockchains is established through the blockchain connection relay server 160 in this manner, the blockchain systems 110, 120, 130, and 140 do not need to establish individual connections with different blockchain systems, whereby more efficient blockchain interoperability may be provided.

Each of the blockchain connection servers 111, 121, 131, and 141 may install and run a connection module therein, and the blockchain connection servers 111, 121, 131, and 141 may be nodes respectively corresponding to the blockchain systems 110, 120, 130, and 140.

The blockchain interoperation system illustrated in FIG. 1 may provide dApp-based interoperability, and particularly, it may operate based on a blockchain-agnostic protocol.

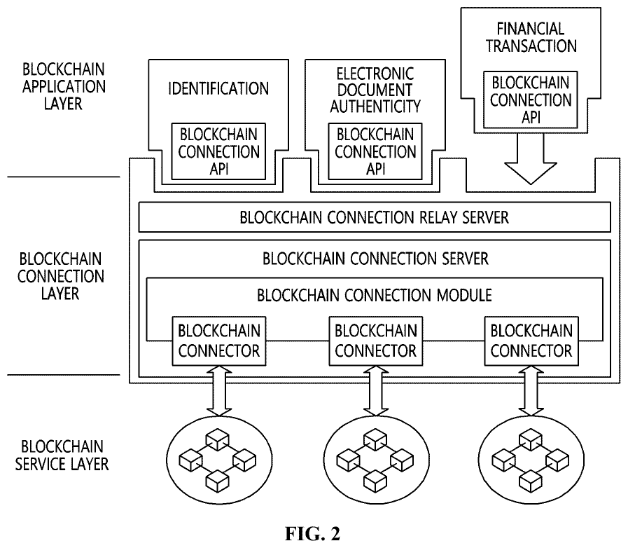

FIG. 2 is a view illustrating the software hierarchy of the blockchain interoperation system illustrated in FIG. 1.

Referring to FIG. 2, it can be seen that a blockchain connection layer is present above a blockchain service layer and a blockchain application layer is present above the blockchain connection layer.

Functions for identification, verification of the authenticity of electronic documents, or financial transactions may be provided through the blockchain application layer, and the blockchain service layer corresponds to blockchain systems.

The blockchain connection layer corresponds to a blockchain connection relay server and a blockchain connection server including a blockchain connection module, and may be connected with the blockchain systems through blockchain connectors.

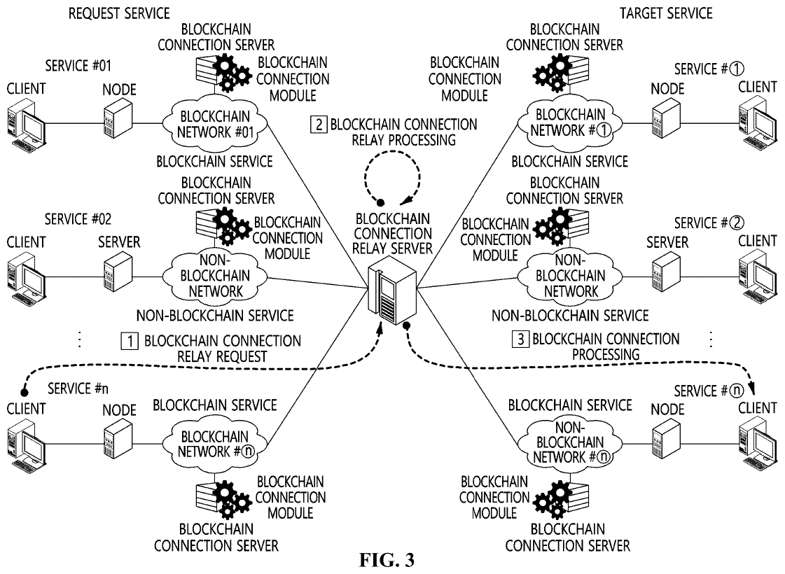

FIG. 3 is a view illustrating the software processing flow of the blockchain interoperation system illustrated in FIG. 1.

Referring to FIG. 3, it can be seen that a blockchain connection relay request from a client corresponding to service #n is provided to a blockchain connection relay server through the blockchain connection module of a blockchain connection server corresponding to blockchain network #n and that the result of blockchain connection relay processing by the blockchain connection relay server is provided to a client corresponding to service #\textcircled{n} through the blockchain connection module of a blockchain connection server corresponding to blockchain network #\textcircled{n}.

In this manner, efficient interoperability between heterogeneous blockchains may be provided through the blockchain connection relay server.

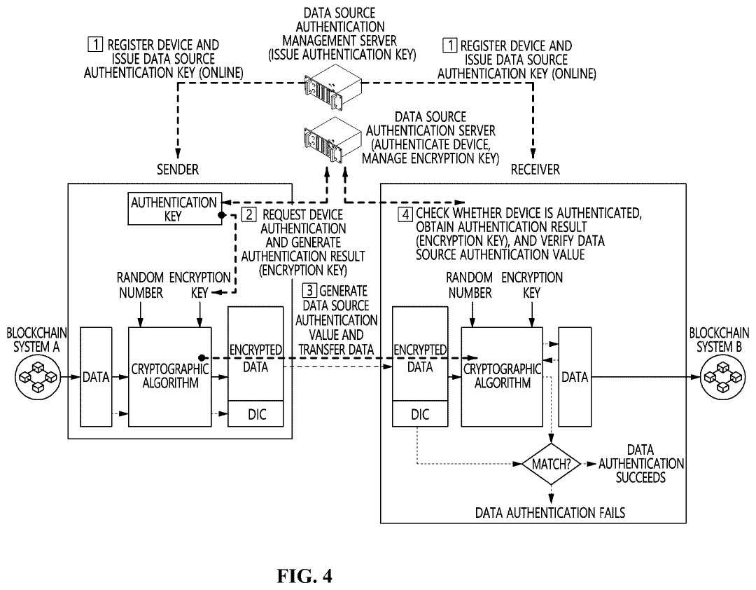

FIG. 4 is a view illustrating an online blockchain data source authentication process according to an embodiment of the present disclosure.

Referring to FIG. 4, in the online blockchain data source authentication process according to an embodiment of the present disclosure, first, a sender client device and a receiver client device may register themselves in a data source authentication management server in advance and may be issued a data source authentication key online.

Here, the data source authentication management server may correspond to a blockchain data source authentication apparatus.

Using the authentication key issued in advance, the sender client device may request device authentication from a data source authentication server before it transfers data.

Here, the sender client device may request device authentication and issuance of an encryption key by providing device information to the data source authentication server.

Here, when the device authentication succeeds, the data source authentication server may generate an encryption key using the authentication result and issue the encryption key to the sender client device.

The sender client device may retrieve data from blockchain system A and encrypt the data through an encryption key algorithm based on the issued encryption key and a random number.

Here, the sender client device may generate additional verification data using a preset cycle of collecting data from blockchain system A depending on the importance of the data.

Here, the importance of data may correspond to the cycle of collecting the data.

For example, important kinds of data may have frequent data collection cycles, but unimportant kinds of data may have infrequent data collection cycles, depending on the importance of the data.

Here, the sender client device may encrypt the data collected from blockchain system A and the additional verification data.

Here, the additional verification data may include context awareness data for various context attributes, such as an identity, a location, an activity, time, and the like.

Here, the additional verification data may include at least one of identification information of the sender client device, location information, information about blockchain system A, information about an activity (measurement, status, etc.), or time information, or a combination thereof.

Here, the sender client device may generate a data source authentication value for the data retrieved from blockchain system A and transfer the data source authentication value and the encrypted data to a receiver.

Here, the data source authentication value may correspond to a data integrity checksum (DIC).

The receiver client device may receive the data source authentication value and the encrypted data.

Upon receiving the encrypted data, the receiver client device may request confirmation of whether the sender client device is authenticated and the authentication result (the encryption key) from the data source authentication server.

Here, the receiver client device may decrypt the encrypted data through an encryption key algorithm based on the issued encryption key and a random number.

Here, the receiver client device may request the data source authentication server to verify the data source authentication value and the additional verification data.

When the verification succeeds, the data source authentication server may reply to the receiver client device with the verification result.

Here, when the received verification result is success, the receiver client device registers the decrypted data in blockchain system B, whereas when the verification fails, it may discard the decrypted data.

Here, the data source authentication server may verify the decrypted data based on at least one of the identification information of the sender client device, the location information, the information about blockchain system A, the information about an activity (measurement, status, etc.), or the time information, or a combination thereof, which are included in the additional verification data.

Here, the data source authentication server may check the importance of data from the cycle of collecting data, which is included in the additional verification data, and check an authentication validity period based on the importance of the data.

Here, the data source authentication server may verify the data depending on whether the current time at which the data included in the additional verification data is collected corresponds to the authentication validity period.

That is, the data source authentication server includes an authentication management unit and a data source verification unit.

The authentication management unit may perform device authentication based on device information and an authentication key by receiving a request for device authentication from the sender client device and the receiver client device, and when the device authentication succeeds, it may issue an encryption key to the sender client device and the receiver client device, which requested the device authentication.

The data source verification unit may receive, from the receiver client device, a request for verification of the data source authentication value for the data that is transmitted from the sender client device to the receiver client device, and may transmit a verification result to the receiver client device.

It can be seen that the data of blockchain system A may be safely delivered to blockchain system B through the process illustrated in FIG. 4.

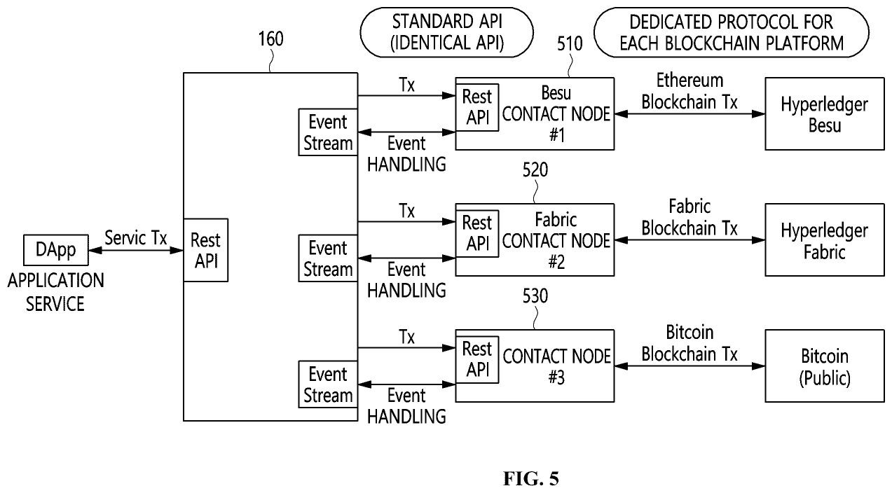

FIG. 5 is a block diagram illustrating an example of an apparatus for providing interoperability between heterogeneous blockchains according to an embodiment of the present disclosure.

Referring to FIG. 5, it can be seen that interoperability between Hyperledger Besu, Hyperledger Fabric, and Bitcoin is provided by a blockchain connection relay server 160. Here, Hyperledger Besu, Hyperledger Fabric, Bitcoin, or the like is an example of heterogeneous blockchains.

Here, contact nodes 510, 520, and 530 may correspond to the blockchain connection servers illustrated in FIG. 1. Here, message transmission/reception between the blockchain connection relay server 160 and the contact nodes 510, 520, and 530 may be based on standard APIs. After that, message transmission/reception between each of the contact nodes 510, 520, and 530 and the corresponding one of the blockchain systems may be based on a dedicated protocol for each blockchain platform.

As illustrated in FIG. 5, the blockchain connection relay server 160 may transmit and receive a service transaction to and from DApp.

Although not explicitly illustrated in FIG. 5, the heterogeneous blockchain systems may include offchain systems.

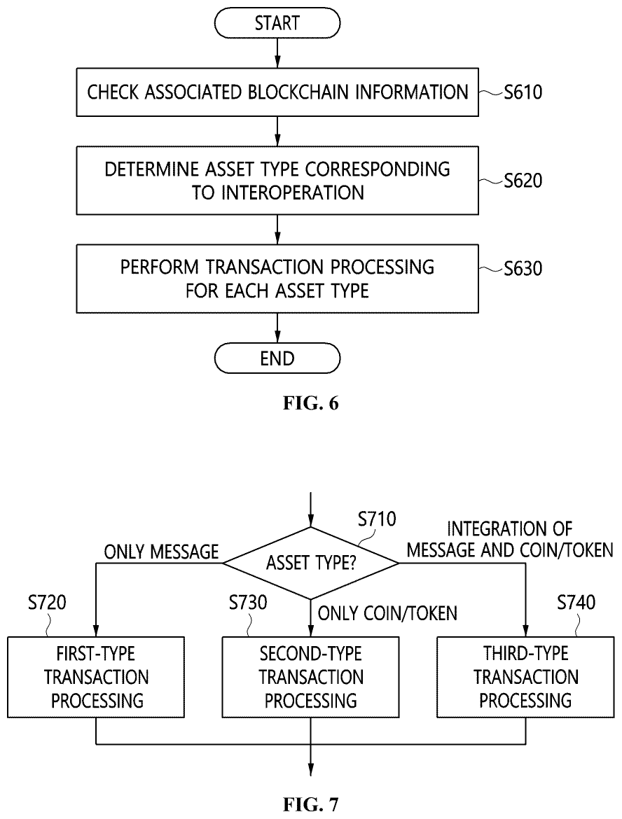

FIG. 6 is a flowchart illustrating a method for providing interoperability between heterogeneous blockchains according to an embodiment of the present disclosure.

Referring to FIG. 6, in the method for providing interoperability between heterogeneous blockchains according to an embodiment of the present disclosure, associated blockchain information is checked at step S610.

Here, the associated blockchain information may be information about blockchain(s) to interoperate with, and may be information registered in a system or collected from the target blockchain through a separate program.

Here, the associated blockchain information may be stored in information storage corresponding to an offchain database.

Here, the associated blockchain information may include information about the authority of access to the blockchains.

Also, in the method for providing interoperability between heterogeneous blockchains according to an embodiment of the present disclosure, an asset type corresponding to the interoperation between the blockchains is determined at step S620.

Here, the asset type may be determined depending on whether an asset includes a coin/token or a message (message or data). Here, the asset type may be determined based on whether the asset corresponding to the interoperation includes a coin/token. Here, the asset type may be determined based on whether the asset corresponding to the interoperation includes a message. Here, when the asset includes a message, whether the message is a large-scale message may be checked.

Here, the message may be data, excluding a token or a coin. Here, massive data may be too large to be stored in a blockchain, and may be stored in an offchain database.

Here, coins may be issued on a main-net and may be issued primarily on public blockchains, whereas tokens may be issued in apps and may be issued on public or private blockchains. However, coins and tokens are not strictly distinguished, and the two terms may be used interchangeably in the present disclosure.

Also, in the method for providing interoperability between heterogeneous blockchains according to an embodiment of the present disclosure, one or more transactions corresponding to the interoperation are processed depending on the asset type at step S630.

The steps illustrated in FIG. 6 may be performed in the order illustrated in FIG. 6, in reverse order, or simultaneously.

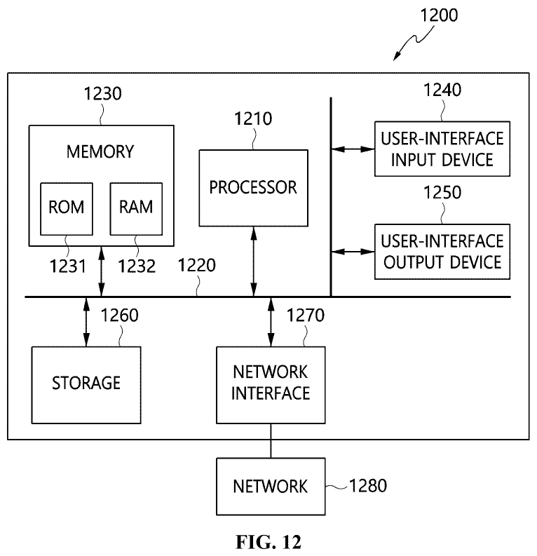

The respective steps illustrated in FIG. 6 may be steps performed by the blockchain connection relay server illustrated in FIG. 1 or the apparatus for providing interoperability between heterogeneous blockchains illustrated in FIG. 12.

Although not explicitly illustrated in FIG. 6, the method for providing interoperability between heterogeneous blockchains according to an embodiment of the present disclosure may further include receiving a message and parsing the received message before step S610.

FIG. 7 is a flowchart illustrating an example of the asset-type-specific transaction processing step (S630) illustrated in FIG. 6.

Referring to FIG. 7, in the asset-type-specific transaction processing step, an asset type is classified at step S710.

As described above, the asset type may be determined depending on whether the asset includes a coin/token or a message (messages or data). Here, the asset type may be determined based on whether the asset corresponding to the interoperation includes a coin/token. Here, the asset type may be determined based on whether the asset corresponding to the interoperation includes a message. Here, when the asset includes a message, whether the message is a large-scale message may be checked.

When the asset type is determined to correspond to only a message at step S710, first-type transaction processing is performed at step S720.

When the asset type is determined to correspond to only a coin/token at step S710, second-type transaction processing is performed at step S730.

When the asset type is determined to correspond to integration of a message and a coin/token at step S710, third-type transaction processing is performed at step S740.

That is, the asset type may be selected from a group including a first type in which the asset corresponding to the interoperation includes a message and does not include a coin/token, a second type in which the asset corresponding to the interoperation includes a coin/token and does not include a message, and a third type in which the asset corresponding to the interoperation includes both a message and a coin/token.

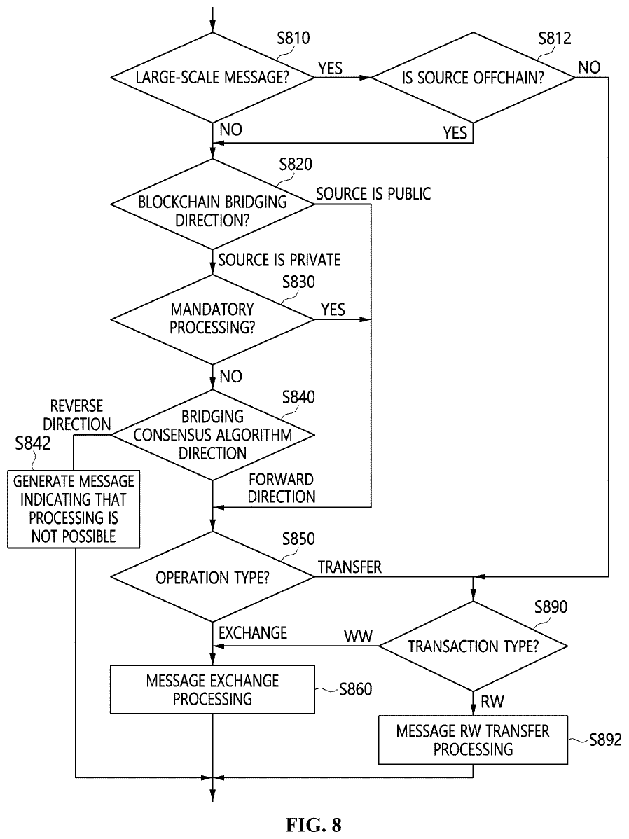

FIG. 8 is a flowchart illustrating an example of the first-type transaction processing step (S720) illustrated in FIG. 7.

Referring to FIG. 8, in the first-type transaction processing step, first, whether the message is a large-scale message is determined at step S810.

That is, whether a transaction corresponding to the interoperation corresponds to a message (data) having a size that can be stored in a blockchain may be determined at step S810. Here, when the data is too large, it cannot be stored in a blockchain and can be stored in a separate offchain database. That is, the size of a block stored in a blockchain is small (e.g., Bitcoin generates a 1 MB block every ten minutes). There is a limit to the size of a transaction that can be stored in a block, and data having a size that cannot be stored in a block of a blockchain may be stored in offchain.

When the message is determined not to be a large-scale message at step S810, a blockchain bridging direction is checked at step S820 in the first-type transaction processing step.

Although it will be described later, the blockchain bridging direction may correspond to whether it is a transaction from a public blockchain to a public blockchain, a transaction from a public blockchain to a private blockchain, a transaction from a private blockchain to a public blockchain, or a transaction from a private blockchain to a private blockchain.

When the message is determined to be a large-scale message at step S810, at least one of a source, or a destination, or a combination thereof is regarded as an offchain, and whether the source is an offchain is checked at step S812 in the first-type transaction processing step.

That is, in the present disclosure, the offchain may be treated as a type of blockchain.

Here, the source may refer to the party that transmits a transaction, and the destination may refer to the party that receives a transaction.

When the source is determined to be an offchain at step S812, transmission of a message (data) from the offchain to a blockchain is determined, and the same process as processing of a message that is not large is performed in the first-type transaction processing step.

When it is determined at step S812 that the source is not an offchain and the destination is an offchain, transmission of a message (data) from a blockchain to an offchain is determined, and a transaction type is checked by going to step S890 in the first-type transaction processing step.

Here, when transmission of a message from a blockchain to an offchain is determined at step S812, an operation may be performed on the assumption that the operation type to be described later is ‘transfer.’

When the message is not a large-scale message or corresponds to processing of a large-scale message from an offchain to a blockchain, a blockchain bridging direction is checked at step S820 in the first-type transaction processing step.

Here, the blockchain bridging direction may correspond to whether it is a transaction from a public blockchain to a public blockchain, a transaction from a public blockchain to a private blockchain, a transaction from a private blockchain to a public blockchain, or a transaction from a private blockchain to a private blockchain.

Here, the blockchain bridging direction may be determined particularly based on whether the source corresponding to the interoperation is a private blockchain.

When the source corresponding to the interoperation is determined not to be a private blockchain at step S820, the operation type is immediately checked at step S850 in the first-type transaction processing step.

That is, when the source corresponding to the interoperation is determined to be a public blockchain at step S820, there is no need to check whether processing is mandatory and to check the direction of a bridging consensus algorithm in the first-type transaction processing step

When the source corresponding to the interoperation is determined to be a private blockchain at step S820, whether processing is mandatory is checked at step S830 in the first-type transaction processing step.

Whether processing is mandatory, e.g., allowing a specific transaction to be processed in a blockchain connection relay server, may be determined based on specifically defined data, unlike a general bridging operation. For example, transaction processing is not allowed when the direction of the bridging consensus algorithm is a reverse direction, but as the result of determination of whether processing is mandatory, if the processing is registered to be specially allowed, the transaction may be processed even when the direction of the bridging consensus algorithm is a reverse direction.

When the transaction is determined to correspond to mandatory processing at step S830, the operation type is immediately checked at step S850 without checking the direction of the bridging consensus algorithm in the first-type transaction processing step.

When it is determined at step S830 that the transaction does not correspond to mandatory processing, the direction of the bridging consensus algorithm is checked at step S840 in the first-type transaction processing step.

Here, the direction of the bridging consensus algorithm may be determined depending on technical priority. That is, transaction processing in the forward direction, from the side with a consensus algorithm with high technical priority (e.g., a complex consensus algorithm or a large number of consensus nodes) to the side with a consensus algorithm with low technical priority (e.g., a simple consensus algorithm or a small number of consensus nodes), is allowed, but a transaction in the opposite direction (reverse direction) may be disallowed.

For example, transaction processing corresponding to exchange may be allowed in the forward direction, but may not be possible in the reverse direction. For example, transaction processing corresponding to transfer may be allowed in the forward direction, but may not be possible in the reverse direction.

Here, in the case of offchain, there is no consensus algorithm, and it may be processed with the lowest technical priority. That is, offchain may be processed with the simplest consensus algorithm. Here, the operation may be processed only when the offchain is a public type or when a policy check is set to mandatory processing.

For example, the direction of the bridging consensus algorithm may be set to the forward direction when the number of consensus nodes of a blockchain consensus committee corresponding to the source is greater than the number of consensus nodes of a blockchain consensus committee corresponding to the destination of the interoperation, but may be set to the reverse direction when the number of consensus nodes of the blockchain consensus committee corresponding to the source is less than the number of consensus nodes of the blockchain consensus committee corresponding to the destination of the interoperation.

When the direction of the bridging consensus algorithm is determined to be the reverse direction at step S840, a message indicating that processing is impossible is generated at step S842 in the first-type transaction processing step.

When the direction of the bridging consensus algorithm is determined to be the forward direction at step S840, the operation type is checked at step S850 in the first-type transaction processing step.

Here, the operation type check process may be performed depending on whether the operation type is ‘transfer’ or ‘exchange.’ Here, when the operation type is ‘exchange,’ only WW is present as a transaction type, whereas when the operation type is ‘transfer,’ the transaction type may be RW or WW.

Here, ‘transfer’ may correspond to asset transfer from the source to the destination, and ‘exchange’ may correspond to asset exchange between the source and the destination. However, even when the asset, such as data or a coin/token, looks like being unidirectionally transferred, if state information, such as a processing result, or the like, is stored in the source, the actual operation type may be ‘exchange’ rather than ‘transfer.’

When the operation type is determined to correspond to ‘exchange’ at step S850, message exchange processing is performed at step S860.

For example, message exchange processing may be performed in the order of storing data in the first blockchain corresponding to the source, hashing the information corresponding to the exchange, and storing data in the second blockchain corresponding to the destination.

When the operation type is determined to correspond to ‘transfer’ at step S850, the transaction type is checked at step S890 in the first-type transaction processing step.

Here, the transaction type may be Write/Write (WW) or Read/Write (RW). Here, WW may indicate that write is performed in the first blockchain and write is performed also in the second blockchain. Here, RW may indicate that read is performed in the first blockchain and write is performed in the second blockchain.

When the transaction type is determined to be RW at step S890, transfer processing for message RW is performed at step S892 in the first-type transaction processing step.

For example, transfer processing for message RW may be performed in the order of retrieving data from the first blockchain, hashing information, and storing the data in the second blockchain.

When the transaction type is determined to be WW at step S890, a step similar to message exchange processing corresponding to step S860 may be performed.

According to an embodiment, transaction types such as RR, WR, etc., may be further present in addition to the transaction types illustrated in FIG. 8.

Particularly, it is necessary to provide consistency processing for WW, and consistency management may be performed through state information management.

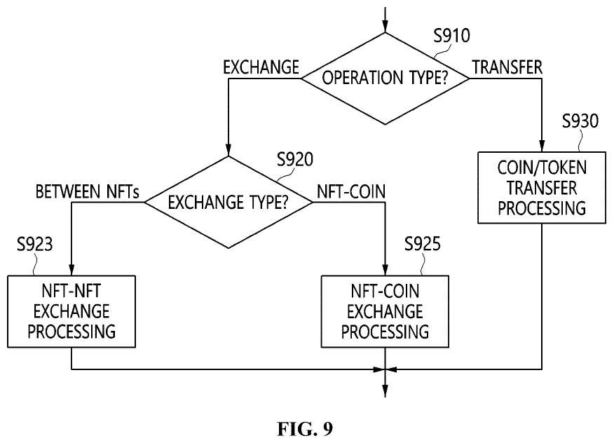

FIG. 9 is a flowchart illustrating an example of the second-type transaction processing step (S730) illustrated in FIG. 7.

Referring to FIG. 9, in the second-type transaction processing step, an operation type is checked at step S910.

Here, the operation type check process may be performed depending on whether the operation type is ‘transfer’ or ‘exchange.’ Here, when the operation type is ‘exchange,’ only WW may be present as a transaction type, whereas when the operation type is ‘transfer,’ the transaction type may be RW or WW.

Here, ‘transfer’ may correspond to asset transfer from a source to a destination, and ‘exchange’ may correspond to asset exchange between the source and the destination. However, even when an asset, such as data or a coin/token, looks like being unidirectionally transferred, if state information, such as a processing result, or the like, is stored in the source, the actual operation type may be ‘exchange’ rather than ‘transfer.’

When the operation type is determined to correspond to ‘transfer’ at step S910, coin/token transfer processing is performed at step S930.

For example, in the case of coin/token transfer processing, coin/token processing for a first blockchain is performed, after which coin/token processing for a second blockchain may be performed.

When the operation type is determined to correspond to ‘exchange’ at step S910, an exchange type is checked at step S920 in the second-type transaction processing step.

In the second-type transaction processing step, when the operation type is determined to be ‘exchange’ at step S910, it may be typically determined to be bridging between public blockchains without data association between the blockchains. Here, the exchange may be mostly assumed to involve associations between NFTs or between an NFT and a coin.

When the exchange type is determined to be the exchange between NFTs at step S920, exchange processing between NFTs is performed at step S923 in the second-type transaction processing step.

For example, exchange processing between NFTs may be performed in the order of checking exchange ratio information, transferring the ownership of the first blockchain, and transferring the ownership of the second blockchain.

When the exchange type is determined to be the exchange between an NFT and a coin at step S920, exchange processing between an NFT and a coin is performed at step S925 in the second-type transaction processing step.

For example, exchange processing between an NFT and a coin may be performed in the order of checking the coin balance, transferring token ownership, and executing coin payment.

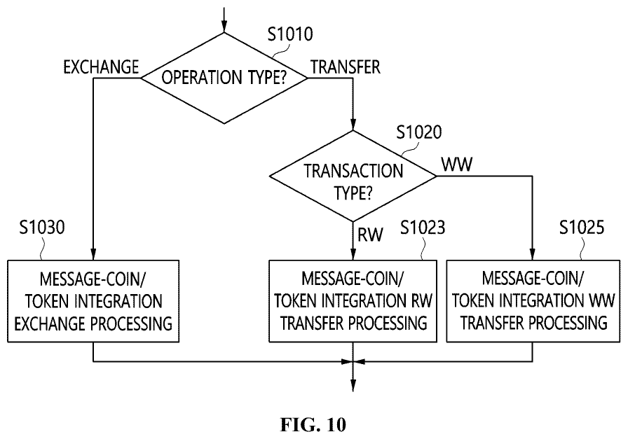

FIG. 10 is a flowchart illustrating an example of the third-type transaction processing step (S740) illustrated in FIG. 7.

Referring to FIG. 10, in the third-type transaction processing step, an operation type is checked at step S1010.

Here, the operation type check process may be performed depending on whether the operation type is ‘transfer’ or ‘exchange.’ Here, when the operation type is ‘exchange,’ only WW may be present as a transaction type, whereas when the operation type is ‘transfer,’ the transaction type may be RW or WW.

Here, ‘transfer’ may correspond to asset transfer from a source to a destination, and ‘exchange’ may correspond to asset exchange between the source and the destination. However, even when an asset, such as data or a coin/token, looks like being unidirectionally transferred, if state information, such as a processing result, or the like, is stored in the source, the actual operation type may be ‘exchange’ rather than ‘transfer.’

When the operation type is determined to correspond to ‘exchange’ at step S1010, message and coin/token integration exchange processing is performed at step S1030.

For example, message and coin/token integration exchange processing may be performed through the processes of locking tokens in a first blockchain, processing a message in a second blockchain, unlocking and processing the tokens in the first blockchain when the above process succeeds, and performing rollback when the above process fails.

When the operation type is determined to correspond to ‘transfer’ at step S1010, a transaction type is checked at step S1020 in the third-type transaction processing step.

Here, the transaction type may be Write/Write (WW) or Read/Write (RW). Here, WW may indicate that write is performed in the first blockchain and write is performed also in the second blockchain. Here, RW may indicate that read is performed in the first blockchain and write is performed in the second blockchain.

When the transaction type is determined to be RW at step S1020, message and coin/token integration RW transfer processing is performed at step S1023 in the third-type transaction processing step.

For example, message and coin/token integration RW transfer processing may be performed in the order of performing message processing in the first blockchain and storing a token in the second blockchain when message processing succeeds.

When the transaction type is determined to be WW at step S1020, message and coin/token integration WW transfer processing is performed at step S1025 in the third-type transaction processing step.

For example, message and coin/token integration WW transfer processing may be performed through the processes of storing a message in the first blockchain, processing a token in the second blockchain when the process succeeds, and updating message state information of the second blockchain when the process succeeds.

According to an embodiment, transaction types, such as RR, WR, and the like, may be further present in addition to the transaction types illustrated in FIG. 10.

Particularly, it is necessary to provide consistency processing for WW, and consistency management may be performed through state information management.

Although not explicitly illustrated in FIG. 10, the third-type transaction processing step may be performed differently depending on whether it involves bridging from a message to a coin/token or bridging from a coin/token to a message.

For example, the process illustrated in FIG. 10 may be applied to bridging from a message to a token/coin, and in the case of bridging from a token/coin to a message, only transfer corresponding to WW is present, so a step similar to step S1025 in FIG. 10 may be performed.

According to an embodiment, the third-type transaction processing step illustrated in FIG. 10 may ensure data consistency by processing a token/coin after processing a message.

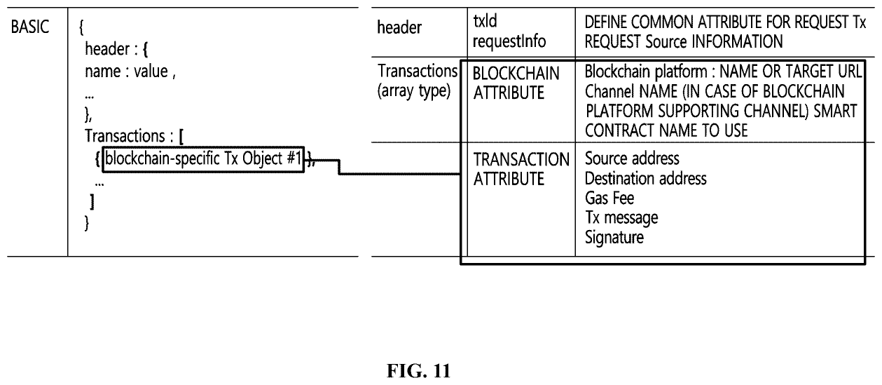

FIG. 11 is a view illustrating a message structure (request) according to an embodiment of the present disclosure.

Referring to FIG. 11, it can be seen that transaction processing requests may be made to multiple blockchain platforms through an array structure. Here, transaction processing may be handled in an asynchronous manner, and after a request, only whether it is received may be returned as a response.

The processing result may be provided based on an event, and a transaction id of each of the blockchains may be returned as a response.

FIG. 12 is a block diagram illustrating a computer system configuration according to an embodiment of the present disclosure.

The blockchain connection relay server, the apparatus for providing interoperability between blockchains, or the apparatus illustrated in FIG. 5 according to an embodiment may be implemented in a computer system 1200 such as a computer-readable recording medium.

The computer system 1200 may include one or more processors 1210, memory 1230, a user-interface input device 1240, a user-interface output device 1250, and storage 1260, which communicate with each other via a bus 1220. Also, the computer system 1200 may further include a network interface 1270 connected to a network 1280. The processor 1210 may be a central processing unit or a semiconductor device for executing a program or processing instructions stored in the memory 1230 or the storage 1260. The memory 1230 and the storage 1260 may be storage media including at least one of a volatile medium, a nonvolatile medium, a detachable medium, a non-detachable medium, a communication medium, or an information delivery medium, or a combination thereof. For example, the memory 1230 may include ROM 1231 or RAM 1232.

Here, at least one program may be recorded in the memory 1230.

Here, the processor 1210 may execute the program. Here, the program determines an asset type corresponding to interoperation between blockchains and processes one or more transactions corresponding to the interoperation depending on the asset type.

Here, the asset type may be selected from a group including a first type in which the asset corresponding to the interoperation includes a message and does not include a coin/token, a second type in which the asset corresponding to the interoperation includes a coin/token and does not include a message, and a third type in which the asset corresponding to the interoperation includes both a message and a coin/token.

Here, transaction processing corresponding to the first type may be performed based on a blockchain bridging direction check process, which is based on a blockchain bridging direction, and a bridging consensus algorithm direction check process, which is based on a bridging consensus algorithm direction.

As described above, the method for providing interoperability between blockchains and the apparatus for the same according to the present disclosure are not limitedly applied to the configurations and operations of the above-described embodiments, but all or some of the embodiments may be selectively combined and configured, so the embodiments may be modified in various ways.

1. A method for providing interoperability between blockchains by a blockchain connection relay server, comprising:
determining an asset type corresponding to interoperation between the blockchains; and
processing one or more transactions corresponding to the interoperation depending on the asset type.

2. The method of claim 1, wherein the asset type is determined based on whether an asset corresponding to the interoperation includes a coin/token.

3. The method of claim 2, wherein the asset type is determined based on whether the asset corresponding to the interoperation includes a message.

4. The method of claim 1, wherein the asset type is selected from a group including:
a first type in which an asset corresponding to the interoperation includes a message and does not include a coin/token,
a second type in which the asset corresponding to the interoperation includes a coin/token and does not include a message, and
a third type in which the asset corresponding to the interoperation includes both a message and a coin/token.

5. The method of claim 1, wherein the blockchains include offchain.

6. The method of claim 4, wherein transaction processing corresponding to the first type is performed based on a blockchain bridging direction check process, which is based on a blockchain bridging direction, and a bridging consensus algorithm direction check process, which is based on a bridging consensus algorithm direction.

7. The method of claim 6, wherein the blockchain bridging direction is determined based on whether a source corresponding to the interoperation is a private blockchain.

8. The method of claim 7, wherein the bridging consensus algorithm direction is set to a forward direction when a number of consensus nodes of a blockchain consensus committee corresponding to the source is greater than a number of consensus nodes of a blockchain consensus committee corresponding to a destination of the interoperation, and is set to a reverse direction when the number of consensus nodes of the blockchain consensus committee corresponding to the source is less than the number of consensus nodes of the blockchain consensus committee corresponding to the destination of the interoperation.

9. The method of claim 8, wherein transaction processing corresponding to the first type comprises generating a message indicating that processing is not possible if the bridging consensus algorithm direction is the reverse direction when the source corresponding to the interoperation is a private blockchain.

10. The method of claim 4, wherein processing the one or more transactions is performed based on an operation type check process, which is based on an operation type corresponding to the interoperation, and a transaction type check process, which is based on a transaction type corresponding to the interoperation and is performed when the operation type is ‘transfer’.

11. The method of claim 10, wherein the operation type check process is performed depending on whether the operation type is ‘transfer’ or ‘exchange’.

12. The method of claim 11, wherein the transaction type check process is performed depending on whether the transaction type is Write/Write (WW) or Read/Write (RW).

13. An apparatus for providing interoperability between blockchains, comprising:
one or more processors; and
executable memory for storing at least one program executed by the one or more processors,
wherein the at least one program determines an asset type corresponding to interoperation between the blockchains and processes one or more transactions corresponding to the interoperation depending on the asset type.

14. The apparatus of claim 13, wherein the asset type is selected from a group including:
a first type in which an asset corresponding to the interoperation includes a message and does not include a coin/token,
a second type in which the asset corresponding to the interoperation includes a coin/token and does not include a message, and
a third type in which the asset corresponding to the interoperation includes both a message and a coin/token.

15. The apparatus of claim 14, wherein transaction processing corresponding to the first type is performed based on a blockchain bridging direction check process, which is based on a blockchain bridging direction, and a bridging consensus algorithm direction check process, which is based on a bridging consensus algorithm direction.
